(19) United States
(12) Patent Application Publication
(10) Pub. No.: US 2006/0266745 A1
(43) Pub. Date: Nov. 30, 2006

(54) Gas shielding apparatus and method of use

(75) Inventor: Michael W. Bruce, Higley, AZ (US)

Correspondence Address: INGRASSIA FISHER & LORENZ, P.C., 7150 E. CAMELBACK, STE. 325, SCOTTSDALE, AZ, 85251, US

(73) Assignee: Honeywell International, Inc., Morristown, NJ (US)

(21) Appl. No.: 11/142,109

(22) Filed: May 31, 2005

(51) Int. Cl. B23K 26/14; B23K 26/20

(52) U.S. Cl. 219/121.84; 219/121.63

(57) ABSTRACT

The present invention provides a gas shielding apparatus for use with free form fabrication techniques such as ion fusion formation. The gas shielding apparatus includes an inner radial wall, an outer radial wall, a ceiling connected to the inner radial wall and the outer radial wall, and a gas dispersal tube disposed on the ceiling. The apparatus may further include a nozzle attachment means connected to one of the ceiling, the inner radial wall, and the outer radial wall. The apparatus may also include a conduit for providing inert gas to the gas dispersal tube. The gas dispersal tube may be hollow and include a plurality of apertures, and the gas dispersal tube may be configured so as to substantially follow a curvature of the outer radial wall.

### FIELD OF THE INVENTION

The present invention relates to gas shielding for welding processes. More particularly the invention relates to a gas shielding apparatus for use in ion fusion formation of free form fabrication structures.

### BACKGROUND OF THE INVENTION

There is an increasing need, for a variety of reasons, to develop methods for the free form fabrication of metallic articles. Free form fabrication generally means the formation of an article by the repetitive deposition of material to create the article in a generally desired shape. Free form fabrication is also characterized by the repetitive deposition of layer upon layer of material in order to build up a structure to a desired dimension.

In the aerospace industry free form fabrication techniques are seen as potentially advantageous. Currently, various casting bodies may be kept in inventory to have on hand for a repair that uses that part. Maintaining such an inventory is expensive and undesirable, especially if the parts themselves are expensive. Consequently some expensive parts may not be inventoried. However, the waiting time for some intricate castings, such as are used for example in valve body housings, is undesirably long. Free form fabrication, if able to quickly produce a near net shape body, would offer an attractive alternative to the current practice of maintaining parts in inventory or special ordering castings. Free form fabrication offers further potential advantages in being able to quickly produce prototype parts, a production advantage that helps to quicken the design and testing process for the part.

One drawback to the technique of free form fabrication, such as for example practiced with ion fusion formation, relates to the physical properties of the material after deposition. Welding typically involves the formation of a molten puddle in a base material and the introduction of new material into the molten pool. However, both the base material and the new material, when in a highly heated condition, are subject to oxidation if exposed to air. The free form fabrication technique is subject to the formation of oxides in that the technique inherently involves the repetitive deposition of one layer of material on top of earlier layers of material. The oxidation of metallic materials is undesirable in that it can lead to brittleness or weakness.

Conventional shielding techniques such as the spray of nozzle gas to blanket an area immediately around the welding nozzle can still leave significant portions of highly heated material exposed to air. This is particularly true in the process of free form fabrication where a workpiece may be rotating or spinning such that a welded area passes away from the area of the nozzle gas. However, many welding techniques, such as for example crack repair, are adapted to localized repairs where localized shielding is adequate. The use of larger welding boxes in which the entire volume is filled with inert gas are expensive and difficult to use with some processes.

Hence, it would be desireable to develop a shielding technique that protects a workpiece from oxidation during a free form fabrication process. A gas shielding apparatus for use with such a technique should be inexpensive and adaptable to different component configurations. The gas shielding apparatus should further provide good shielding against oxidation so that a finished part has improved physical characteristics. As explained further herein, the present invention addresses one or more of these needs.

### SUMMARY OF THE INVENTION

The present invention provides a gas shielding apparatus for providing inert gas shielding. In one embodiment, and by way of example only, there is provided an apparatus that includes an inner radial wall, an outer radial wall, a ceiling connected to the inner radial wall and the outer radial wall, and a gas dispersal tube disposed on the ceiling. The apparatus may further include a nozzle attachment means connected to one of the ceiling, the inner radial wall, and the outer radial wall. The apparatus may also include a conduit for providing inert gas to the gas dispersal tube. The gas dispersal tube may be hollow and include a plurality of apertures, and the gas dispersal tube may be configured so as to substantially follow a curvature of the outer radial wall.

In a further embodiment, still by way of example only, there is provided an apparatus for providing inert gas shielding to a rotating flange that includes a first wall, a second wall, a radial wall connected to the first wall and the second wall so that the first wall, second wall, and the radial wall define a partial inner chamber that partially encloses the flange, a nozzle attachment means connected to at least one of the first wall, the second wall, and the radial wall, and a gas dispersal tube disposed in the partial inner chamber. The nozzle attachment means may be positioned with respect to the first wall, the second wall, and the radial wall such that a rotating weld point on the flange first passes under the nozzle attachment means and then passes into the partial chamber.

In still a further embodiment, and still by way of example only, there is provided a method for providing an inert gas shielding to a welding workpiece that includes the steps of attaching a gas shielding apparatus to a welding nozzle, positioning a partial chamber proximate to the workpiece, flowing inert gas through a gas dispersal tube and out apertures, and partially retaining inert gas within the chamber so as to maintain an inert gas shield proximate the workpiece. The flowing of inert gas may include flowing gas through a conduit into the gas dispersal tube. The workpiece may be rotated such that a weld point passes under a nozzle attachment means and then into the partial chamber.

Other independent features and advantages of the gas shielding apparatus will become apparent from the following detailed description, taken in conjunction with the accompanying drawings which illustrate, by way of example, the principles of the invention.

### BRIEF DESCRIPTION OF THE DRAWINGS

FIG. 1 is a perspective view of a gas shielding apparatus, according to an embodiment of the present invention;

FIG. 2 is a bottom view of the gas shielding apparatus, according to an embodiment of the present invention;

FIG. 3 is a perspective view of a gas shielding apparatus in operation with a welding nozzle and workpiece, according to an embodiment of the present invention;

FIG. 4 is a side view of a further embodiment of a gas shielding apparatus, according to an embodiment of the present invention;

FIG. 5 is a front view of the embodiment of the gas shielding apparatus of FIG. 4; and

FIG. 6 is a flow chart that illustrates steps in a method of using the gas shielding apparatus, according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

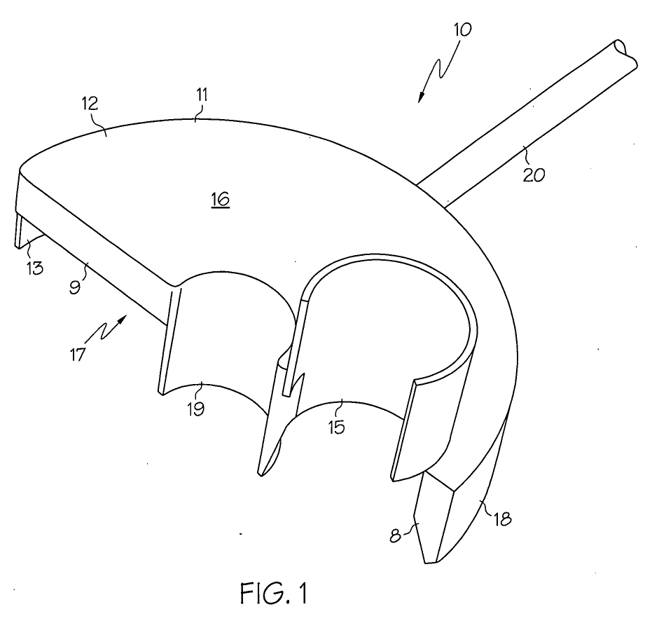

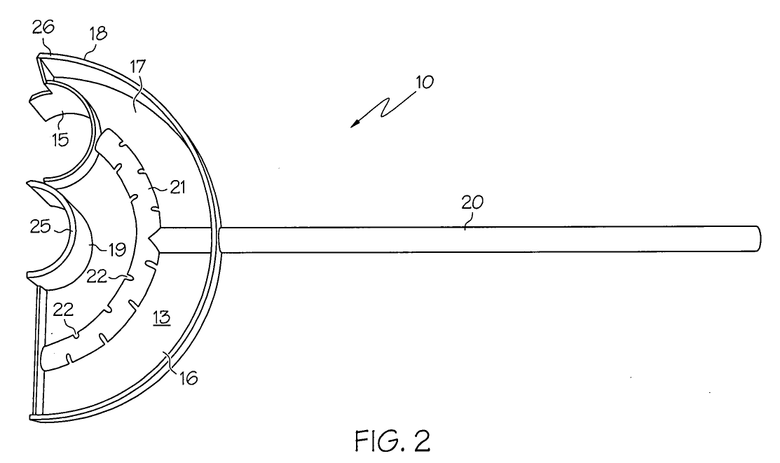

Referring now to FIGS. 1 and 2 there is shown an embodiment of a gas shielding apparatus 10. The gas shielding apparatus 10 generally includes a housing 11 that defines a partial chamber 17 for containing a gas shield. Housing 11 includes an outer surface 12 and an inner surface 13 (shown in FIG. 2). Components of housing 11 include nozzle attachment means 15, ceiling 16, outer radial wall 18, and inner radial wall 19. Housing 11 also includes a nozzle wall 8 and end wall 9. Gas shielding apparatus 10 also includes conduit 20 and gas dispersal tube 21 (see FIG. 2).

Nozzle attachment means 15, in one embodiment, defines a partial cylindrical wall. The dimension of nozzle attachment means 15 is selected so as to match a surface of a welding nozzle (not shown), and thus nozzle attachment means 15 may have other configurations. Gas shielding apparatus 10 can be attached to a welding nozzle by securing the nozzle attachment means 15 to the welding nozzle.

Inner radial wall 19, in one embodiment, also defines a partial cylindrical wall. Outer radial wall 18 also preferably defines a partial cylindrical wall. Further, the partial cylinders defined by inner radial wall 19 and outer radial wall 18 share the same center point so that inner radial wall 19 and outer radial wall 18 are in a coaxial arrangement. As shown in the embodiment of FIG. 1, inner radial wall 19 and outer radial wall 18 each have a length, which may be different, so that each wall 18, 19 defines a bottom edge, inner bottom edge 25 and outer bottom edge 26.

Ceiling 16 is joined to outer radial wall 18, nozzle attachment means 15, inner radial wall 19, nozzle wall 8, and end wall 9. The inner surfaces 13 of ceiling 16, outer radial wall 18, and inner radial wall 19 define, at least in part, partial chamber 17. Nozzle attachment means 15, nozzle wall 8, and end wall 9 may also define in part the partial chamber 17. The joining of these components is preferably done so as to restrict, in part, the passage of gas through the connections. It is noted, however, that partial chamber 17 is open to the surrounding atmosphere at a bottom portion.

As shown in FIG. 2, conduit 20, in one embodiment, comprises a hollow passageway through which gas can flow. Conduit 20 is attached to the gas shielding apparatus 10, preferably through outer radial wall 18, so as to provide fluid communication between the conduit 20 and the interior of the gas shielding apparatus 10. Preferably conduit 20 is further connected to gas dispersal tube 21. Gas dispersal tube 21 also comprises a hollow passageway for transporting shielding gas. Gas dispersal tube 21 preferably is disposed in a generally arc-like configuration so as to concentrically follow the curves defined by outer radial wall 18 and inner radial wall 19. Alternatively, at least a portion of gas dispersal tube is arc shaped. Further, gas dispersal tube 21 is preferably positioned so as run along the inner surface 13 of ceiling 16 so as to be approximately positioned equally between outer radial wall 18 and inner radial wall 19. Additionally, gas dispersal tube 21 includes a plurality of apertures 22. Apertures 22 are preferably spaced along the length of gas dispersal tube 21. The apertures 22 may further be positioned on gas dispersal tube 21 so as to direct inert gas in a preferred direction within partial chamber 17. In one embodiment, apertures 22 direct inert gas generally toward inner radial wall 19 or generally toward outer radial wall 18.

Conduit 20 preferably enters the gas shielding apparatus 10 through a hole (not shown) in outer radial wall 18. However, other configurations may be used. For example, the conduit 20 may enter through ceiling 16. In addition, it is possible to create a gas shielding apparatus 10 that uses some means for transporting inert gas other than a rigid conduit 20. A flexible hose with or without an attachment, for example, may be connected with the apparatus 10 as a means of providing an inert gas feed.

In a further embodiment of the gas shielding apparatus 10, a distributor plate (not shown) is used in conjunction with the gas dispersal tube 21. A distributor plate, a plate with a number of openings, is positioned below the gas dispersal tube 21. The openings in the distributor plate aid in evenly distributing inert gas so that the inert gas enters the chamber from a generally upper to lower direction. Alternatively, a screen may be used instead of a distributor plate. It has also been found advantageous to pack the area around the gas dispersal tube 21 with a baffling material such as steel wool. The steel wool may be held in position against the gas dispersal tube 21 by, for example, a distributor plate. The steel wool further helps to disperse inert gas. Further, the gas shielding apparatus 10 may be used with more than one gas dispersal tube 21.

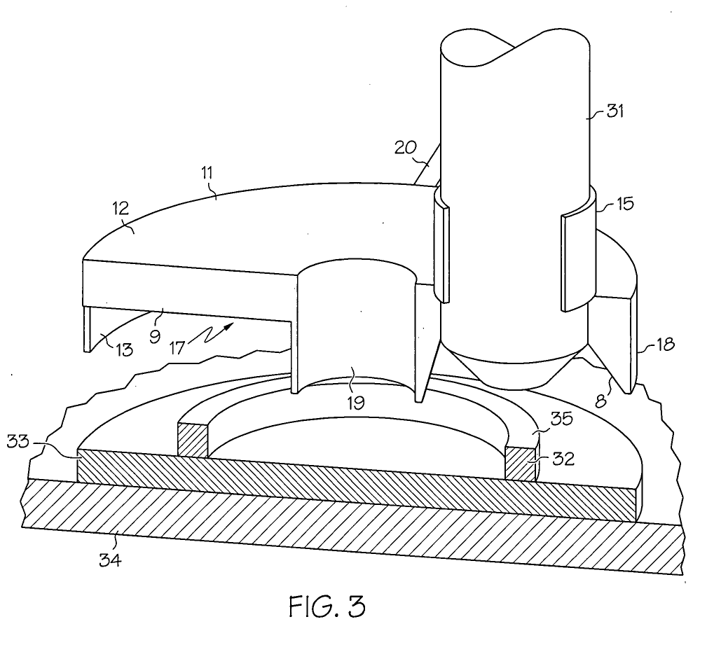

The shape and function of the gas shielding apparatus 10 can be further understood in relation to an intended use of the apparatus 10. Referring now to FIG. 3 there is shown a gas shielding apparatus 10 disposed in conjunction with a welding nozzle 31 and workpiece 32. Workpiece 32 is placed on a base 33, and base 33 is connected to control table 34. As is known in the art, control table 34 can be configured to move in x, y, and z directions, including providing rotational and tilting movements. The workpiece 32 is, in one embodiment, a generally cylindrical piece such as may be used to fabricate the cylindrical wall of a valve housing. Control table 34 is made to rotate, thereby rotating base 33 and workpiece 32. Holding welding nozzle 31 in a relatively stationary position, nozzle 31 provides the welding of material that is deposited onto workpiece 32. The welding is further facilitated by the addition of some material through a material feeding device (not shown) such as a powder feeder or a wire feeder. It will be appreciated by those skilled in the art that workpiece 32 may be built up to desired dimensions, such as in thickness and height, by controlling the amount of material deposited thereon in successive welding passes. Oscillation movement may further help in creating a workpiece 32 with a desired wall thickness.

As shown in FIG. 3 gas shielding apparatus 10 is disposed so as to assist in the welding operation. Gas shielding apparatus 10 acts to retain shielding gas around and in proximity to workpiece 32. Shielding gas is pumped through conduit 20 so as to enter gas dispersal tube 21. The shielding gas then runs through gas dispersal tube 21 and exits through apertures 22. Shielding gas that exits through apertures 22 is thus positioned generally above the workpiece 32 within partial chamber 17. As a stream of shielding gas exits apertures 22 the gas surrounds that surface of workpiece 32 that has recently been exposed to welding. Shielding gas continues to shield workpiece 32 until the shielding gas reaches a bottom of some portion of gas shielding apparatus 10 such as a bottom edge of outer radial wall 18 or inner radial wall 19. At that point the shielding gas is no longer confined by the partial chamber 17 of gas shielding apparatus 10 and the shielding gas can disperse to the surrounding atmosphere.

Still referring to FIG. 3 it will be appreciated that workpiece 32 is rotating during a welding operation. Newly deposited material is thus being added to workpiece 32 in the general position under nozzle 31, referred to as a weld point 35. In actual practice it will be appreciated that weld point 35 is a continuous deposition of material; however, the consideration of a single point as it passes from welding to cooling helps to illustrate an embodiment of the invention. It is when the weld point 35 rotates past nozzle 31 that the weld point 35 benefits from inert gas shielding because immediately after welding the added material is subject to oxidation. Thus, the gas shielding apparatus 10 is positioned so as to generally cover or overlie that portion of workpiece 32 that has just been welded. Described another way, the weldpoint 35 rotates from a position under nozzle 31 to a position within partial chamber 17 that underlies gas shielding apparatus 10. Further, gas shielding apparatus 10 is preferably sized so as to have a sufficient dimension to provide inert gas shielding to recently welded material such that the weld point is substantially protected against oxidation during that period of cooling when the weld point is subject to oxidative forces. Additionally, a sufficient volume flow of shielding gas is set so as to provide blanketing within the partial chamber 17. Thus, use of the gas shielding apparatus allows the welding of a workpiece 32 without the need for other protective means such as enclosures or inert gas welding boxes.

In a preferred embodiment, components of the gas shielding apparatus are fabricated of stainless steel; 300 series stainless steel is also preferred as a construction material. In one embodiment, a subassembly comprising ceiling 16, inner radial wall 19, and outer radial wall 18 is fabricated from stainless steel bar stock. In that embodiment, a cylinder of stainless steel is machined so as to form a structure having the ceiling 16, inner radial wall 19, and outer radial wall 18 features. In an alternative embodiment, the gas shielding apparatus 10 may be assembled from individual components by welding the pieces together.

The overall shape of an embodiment of gas shielding apparatus 10 is shown to be in the general shape of a half circle. The shape, and thus the size of the partial chamber 17, may be greater or less. It is generally preferred, however, to provide some open space in the area around the welding nozzle 31. This allows for an operator to have a good view of the workpiece 32 where the weld point 35 is located. In addition it allows some space for ancillary welding systems such as a wire feeder (or power feeder) or a vision system. It will also be appreciated that the shape described, for example in FIGS. 1 and 2, may be adapted for use with different size workpieces. Thus, if it is desired to construct a cylindrical workpiece with a relatively large radius, the gas shielding apparatus can be adapted by similarly expanding the radius of the outer radial wall 18 and inner radial wall 19, and sizing related pieces to fit. Further, the relationship between various components may be set at various angles rather than the approximately right angles as shown in the figures. The joints need not be pronounced but may be curved or gradual. If desired a single bent sheet may provide the function of a ceiling 16, inner radial wall 19, and outer radial wall 18. Additionally, inner radial wall 19 and outer radial wall 18 need not be curved or arcuate in shape. Inner radial wall 19 and outer radial wall 18 may be straight. Thus, in a further embodiment, gas shielding apparatus 10 is generally rectangular or box-like in shape.

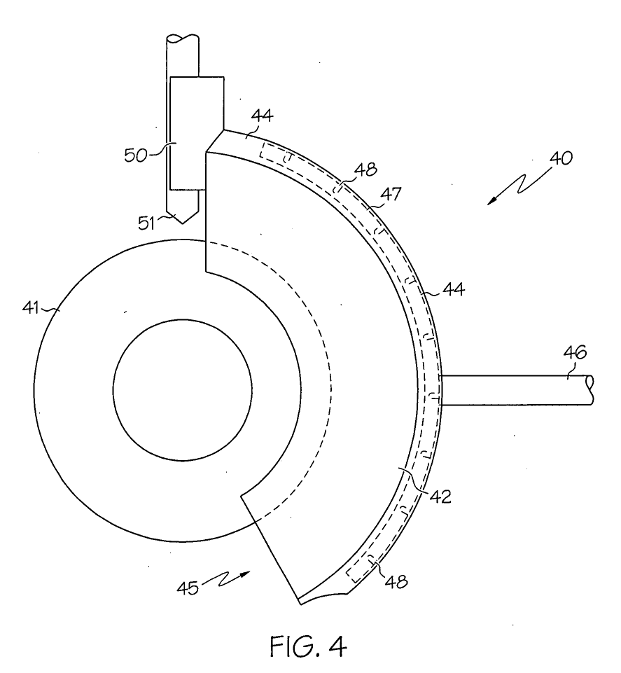

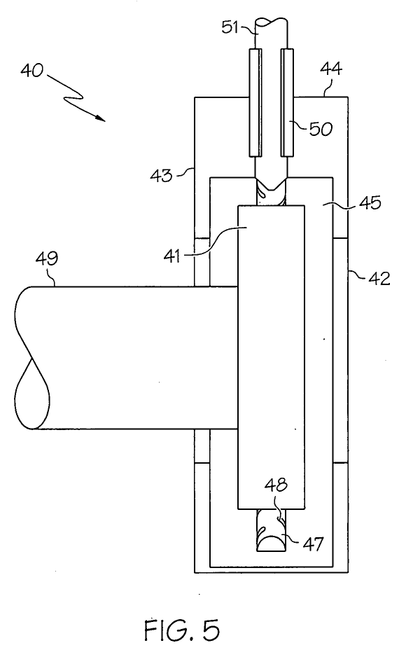

Referring now to FIGS. 4 and 5, there is shown a further embodiment of a gas shielding apparatus 40. The embodiment in FIGS. 4 and 5 is advantageous in a free form fabrication process that is used to create a workpiece having a flange 41. As shown in FIG. 4, a flange 41 is being built up on a core 49 such as a spool, or, as shown a hollow cylinder. A flange 41 is a typical structure that is often a useful addition to a valve body. Thus, for example, after fabricating a cylinder wall, it may be useful to then create a flange at one end of the cylinder wall. The geometry of the flange 41 may make it difficult, however, to use the gas shielding apparatus of FIGS. 1 and 2.

In FIGS. 4 and 5 the gas shielding apparatus 40 includes two side walls 42 and 43 and a radial wall 44. The side walls 42, 43, and radial wall 44, are connected so as to form a partial interior chamber 45. The partial interior chamber 45 has a shape that generally allows a flange 41 to rotate therein. The gas shielding apparatus 40 further includes a conduit 46 and gas dispersal tube 47 (shown in dashed outline in FIG. 4). In this embodiment, the gas dispersal tube 47 is preferably positioned within the interior chamber 45 along a surface of radial wall 44. As before, fluid communication between conduit 46 and gas dispersal tube 47 allows inert gas to pass from the conduit 46, into the gas dispersal tube 47, and into the interior chamber 45 through apertures 48 in the gas dispersal tube 47. Steel wool and a distributor plate may be used, if desired.

FIGS. 4 and 5 further illustrate that a nozzle attachment means 50 is positioned so as to attach to radial wall 44 and/or side wall 42 and/or side wall 43. Nozzle attachment means 50 is again configured to match an outer contour of a welding nozzle 51 so that the nozzle attachment means 50 may be secured thereto. Thus, in one embodiment, radial 44 is arcuate in shape with a curvature that generally matches the curvature of a flange to be shielded. Further side walls 42 and 43 are spaced, by their connection with radial wall 44, so as to sandwich the flange while leaving space for the workpiece rotation and gas shielding. The direction of rotation of the workpiece is such that a weld point first passes under welding nozzle 51 and then passes into the interior chamber 45 of the gas shielding apparatus 40.

As with the embodiment in FIGS. 1 and 2, the gas shielding apparatus shown in FIGS. 4 and 5 may be sized to adapt to varying workpiece sizes. The components may be curved or angled other than as shown in the figure. The apparatus may have outer shapes other than the shape illustrated, including a rectangular or box-like shape.

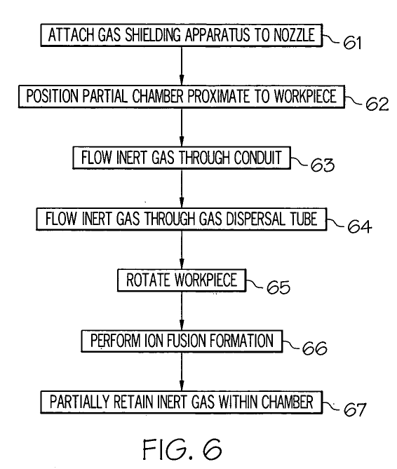

Having described the gas shielding apparatus from a structural standpoint, a method of using the gas shielding apparatus will now be described. The following description of the method may also reference steps shown in the flowchart of FIG. 6.

The gas shielding apparatus is first positioned with respect to a welding device. In a preferred embodiment, nozzle attachment means 15 is sized so that it slides over a welding nozzle. Further, the nozzle attachment means 15 fits snugly with respect to the welding nozzle so that, either by friction or an additional attachment means, the gas shielding apparatus 10 is affixed to the welding nozzle, step 61. In one embodiment, the nozzle attachment means 15 has a slip fit over the welding nozzle, and the nozzle attachment means 15 is then compressed by a clamp to attach to the welding nozzle. A worm drive hose clamp can be used to make the attachment.

The act of attaching the nozzle attachment means 15 to the welding nozzle further includes the axial positioning of the gas shielding apparatus 10. For example, the higher that the nozzle attachment means 15 is moved onto the welding nozzle, the farther away the apparatus 10 will be from the workpiece. Thus, the nozzle attachment means 15 is positioned so that the gas shielding apparatus 10 is placed in a desired location, preferably so that the partial chamber is proximate to the workpiece, step 62. Further, the positioning of the gas shielding apparatus 10 is such that the edge of outer radial wall 18 and inner radial wall 19 are a desired distance from a workpiece or base.

Once the gas shielding apparatus 10 is positioned, welding deposition can begin. The gas shielding apparatus 10 may be used in a number of different welding operations. However, the apparatus 10 has particular application in the process to form free standing articles using ion fusion formation, step 66. Thus, a welding operation includes the deposition of material. In the fusion formation process material is deposited onto a base that preferably matches the material of deposition. Rotation of the base, step 65, causes material to be deposited over previously deposited layers of material so that a build up takes place. In this manner a newly formed article is created, such as for example a cylindrically shaped body.

When welding commences, or even prior to welding commencement, inert gas is made to flow through conduit 20 and into gas dispersal tube 21, step 63. The flow of inert gas may be achieved through conventional gas handling equipment. Thus, for example, a pump transfers gas from a storage container, through a tubing. The tubing is connected to conduit 20 and passes inert gas into the conduit 20. Inert gas that enters the conduit 20 then flows through the dispersal tube 21 and then out of the dispersal tube 21 through the apertures 22 into partial chamber 17, step 64. The inert gas within the partial chamber 17 of the gas shielding apparatus 10 surrounds the workpiece and provides an inert gas shielding that prevents oxidation of the workpiece, step 67.

It will be appreciated that inert gas that is directed into the partial chamber 17 is eventually free to leave the partial chamber 17 and disperse to the atmosphere by passing through the exposed bottom area of the chamber 17. However, in practice, a volume of inert gas is constantly dispersed into the partial chamber 17 so that gas that exits the chamber 17 is being replaced by newly entering gas. Further, a gas flow rate can be selected so that newly entering gas also is acting to push out gas that is in the chamber 17. In this manner having a positive displacement of inert gas maintains a shield of inert gas around the workpiece.

As welding deposition continues, a volume of material begins to define the workpiece. As new deposition layers begin, the welding nozzle will be pulled away from the workpiece surface in order to maintain the tip of the welding nozzle a desired distance from the workpiece. Movement of the welding nozzle also moves the gas shielding apparatus 10, which is attached to the nozzle. Thus, as welding continues to build up the workpiece, the welding nozzle and the gas shielding apparatus 10 stay in a desired position relative to the workpiece.

While the gas shielding apparatus has been adapted for use with free form fabrication techniques, it is also useful as a shielding device in other welding operations. When used with the ion fusion formation process, the apparatus has been used with a variety of gas feed rates, including rates in the range of between about 20 to about 30 ft³/hr of argon gas. Similarly, the rotation rate of the workpiece may vary, and the linear speed has varied between about 5 to about 15 inches/minute. Ion fusion formation may take place using a variety of power levels that depend, for example, on the geometry of the workpiece. A typical build up uses a power that draws about 80 to about 180 amps at about 18 to about 22 volts. It is possible, however, to perform an operation with as little as 5 amps at up to about 400 amps. It will be appreciated, however, that these levels are reflective of current technology, and the gas shielding apparatus may be used with welding techniques that use different energy levels, gas feed rates, and rotation rates.

In one example that illustrates aspects of the invention, two cylindrical workpieces were deposited using ion fusion formation techniques. The workpiece was formed of stainless steel 347. In a first case, the workpiece was deposited using conventional shielding practices. In a second case, the workpiece was formed using inert gas shielding as described in the present application. The pieces were then tested for ultimate strength, yield strength, and elongation (ductility). In each case, the workpiece deposited using the gas shielding apparatus showed properties at least as good as those for wrought and cast materials. However, in the category of elongation, the workpiece that was formed using the gas shielding apparatus showed a marked improvement in ductility as compared to the piece that did not use the shielding apparatus. The following table shows a comparison of properties among various pieces.

TABLE 1

| | | | | |
|---|---|---|---|---|
| | | | Typical | Typical |
| | New | Conventional | Wrought | Cast |
| Shielding/Material | Shielding | Shielding | Material | Material |

| | | | | |
|---|---|---|---|---|
| Ultimate Strength | 85.1-85.6 | 80.9-84.1 | 75 min. | 70 min. |
| (ksi) | | | | |
| Yield Strength | 49.7-50.1 | 57.1-58.2 | 30 min. | 30 min. |
| (ksi) | | | | |
| Elongation (%) | 46-54 | 11-18 | 40 min. | 30 min. |

The piece formed following conventional shielding shows a strength that is comparable to the wrought material; however its ductility is significantly lower than conventional wrought material. On the other hand, the piece formed using the new shielding technique, which limits oxidation in the material, shows marked improvement in ductility (46-54% elongation) while retaining strength characteristics that compare favorably to a wrought material. It is noted that the wrought material in Table 1 is a material formed according to standard AMS—QQ—S—763 with a material tested at greater than 0.5 inch thickness. The cast material is material prepared according to standard AMS—5362 for investment castings.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for providing inert gas shielding to a rotating workpiece receiving a welding operation on a weldpoint from a welding nozzle, the apparatus comprising:
a housing having an inner surface that defines a partial chamber configured so as to partially enclose at least a portion of the workpiece;
a nozzle clamp coupled to the housing and configured so as to attach to the welding nozzle so that the weldpoint of the workpiece rotates within the partial chamber after receiving a welding operation; and
a gas disperser disposed within the chamber, the gas disperser adapted to receive a flow of shield gas from a shield gas source and configured, upon receipt of the shield gas, to disperse the shield gas within the chamber.

2. The apparatus according to claim 1 further comprising a gas dispersal tube in fluid communication with a conduit, the gas dispersal tube disposed on the housing and configured so as to disperse inert gas within the partial chamber.

3. The apparatus according to claim 1 wherein the housing comprises an inner radial wall, an outer radial wall and a ceiling connected to the inner radial wall and the outer radial wall.

4. The apparatus according to claim 3 wherein the inner radial wall and the outer radial wall define partial circular arcs having a common centerpoint.

5. The apparatus according to claim 3 further comprising a nozzle wall and an end wall, each affixed to the inner radial wall and the outer radial wall.

6. The apparatus according to claim 2 wherein the partial chamber defines a curvature and wherein the gas dispersal tube is hollow and includes a plurality of apertures, the gas dispersal tube configured so as to substantially follow the curvature of the partial chamber.

7. The apparatus according to claim 2 further comprising more than one gas dispersal tubes.

8. The apparatus according to claim 1 wherein the housing comprises stainless steel.

9. An apparatus for providing inert gas shielding to a rotating flange having a weldpoint comprising:
a housing defining a partial inner chamber that partially encloses the flange;
a nozzle clamp connected to the housing, the nozzle clamp configured so that the weldpoint rotates past the nozzle clamp and into the partial inner chamber; and
a conduit configured to provide inert gas to the partial inner chamber.

10. The apparatus according to claim 9 further comprising a gas dispersal tube disposed in the partial inner chamber, the gas dispersal tube in fluid communication with the conduit, the gas dispersal tube configured so as to disperse inert gas within the partial chamber.

11. The apparatus according to claim 9 wherein the housing comprises a first wall, a second wall, and a radial wall connected to the first wall and the second wall so that the first wall, the second wall, and the radial wall define the partial inner chamber.

12. The apparatus according to claim 11 wherein a gas dispersal tube is connected to the radial wall and approximately equally spaced between the first wall and the second wall.

13. The apparatus according to claim 12 wherein the gas dispersal tube is hollow and includes a plurality of apertures, the gas dispersal tube configured so as to substantially follow the curvature of the radial wall.

14. The apparatus according to claim 9 wherein the flange receives a welding operation with a welding nozzle and wherein the nozzle clamp is configured to attach to the welding nozzle.

15. A method of providing an inert gas shielding to a rotating workpiece, the method comprising the steps of:
positioning a partial chamber proximate to the workpiece;
flowing inert gas through a gas dispersal tube and out apertures;
rotating the workpiece such that a weld point on the workpiece passes under a nozzle clamp and then into the partial chamber; and
partially retaining inert gas within the partial chamber so as to maintain an inert gas shield proximate the workpiece.

16. The method according to claim 15 further comprising flowing inert gas through a conduit into the gas dispersal tube.

17. The method according to claim 15 further comprising attaching the nozzle clamp of a gas shielding apparatus to a welding nozzle thereby affixing the gas shielding apparatus to the welding nozzle.

18. The method according to claim 15 further comprising performing an ion fusion formation welding on the workpiece.

19. The method according to claim 15 wherein the partial chamber is defined by a ceiling, an outer radial wall and an inner radial wall.

20. The method according to claim 15 wherein the partial chamber is defined by a first wall, a second wall, and a radial wall.
